(19) United States
(12) Patent Application Publication
(10) Pub. No.: US 2006/0055329 A1
(43) Pub. Date: Mar. 16, 2006

(54) Extra-high pressure mercury lamp

(75) Inventors: Takashi Yamashita, Hyogo (JP); Atsushi Imamura, Hyogo (JP); Tetsuji Hirao, Hyogo (JP)

Correspondence Address: RADER FISHMAN & GRAUER PLLC, LION BUILDING, 1233 20TH STREET N.W., SUITE 501, WASHINGTON, DC, 20036, US

(73) Assignee: USHIO DENKI KABUSHIKI KAISHA

(21) Appl. No.: 11/221,768

(22) Filed: Sep. 9, 2005

(30) Foreign Application Priority Data
Sep. 10, 2004 (JP) 2004-264052

(51) Int. Cl. H01J 17/04

(52) U.S. Cl. 313/631

(57) ABSTRACT

The present invention relates to an extra-high pressure mercury lamp in which 0.15 mg/mm3 or more of mercury is filled as light emitting material, and a pair of electrodes facing each other is disposed in an arc tube, in which at least one of the pair of electrodes has an axis portion, and a thick diameter portion formed by winding a coil around the axis portion, the thick diameter portion comprising a winding portion provided on the axis portion, and a curvature portion which is integrally formed with the axis portion, and has a curved portion at least in part around a circumference of the axis portion between the axis portion and the curvature portion, and the curved portion connected to a back end portion of the winding portion.

### TECHNICAL FIELD OF THE INVENTION

The present invention relates to a mercury lamp in which at time of lighting, the mercury vapor pressure reaches 15 mg/mm³ or more in the arc tube of a projector apparatus, such as a DLP (digital light processor) which uses a liquid crystal display apparatus or a DMD (digital mirror device).

### DESCRIPTION OF RELATED ART

In a projection type projector apparatus represented by the DLP etc. which uses the liquid crystal projector or the DMD, since illumination of an image with uniformity and sufficient color rendering properties on a rectangle screen is required, a metal halide lamp in which mercury or metallic halide is enclosed has been used as a light source.

Recently, miniaturization of a lamp and developments of a point light source has been further advanced, so that a lamp having a very short distance between electrodes has been reduced to practice.

In recent years, in view of the background, a lamp with high mercury vapor pressure at time of lighting, such as 150 atmospheric pressure, which had never been developed, is proposed in place of such a metal halide lamp. In such a lamp, by making the mercury vapor pressure higher, light output can be further improved while a spread of an arc is controlled (narrowed). Such an extra-high pressure discharge lamp is disclosed in, for example, Japanese Laid Open Patent Nos. 2-148561 and 6-52830.

According to these references, a pair of electrodes is disposed facing each other in an arc tube in which a spherical light emitting portion is disposed at the center thereof. In the inner space of the arc tube, a certain amount of halogen gas for carrying out halogen cycle is enclosed, while mercury of 0.15 mg/mm³ or more is enclosed therein.

In the extra-high pressure mercury lamp, as disclosed in, for example, Japanese Laid Open Patent No. 2001-319617, in order to make it easy to carry out a shift from glow discharge to arc discharge at beginning of lighting, a coil is often provided so as to be exposed to the electrical discharge space near the tip of the electrode.

### SUMMARY OF THE INVENTION

Since in recent years, in a high pressure mercury lamp used in a projector apparatus, miniaturization of the lamp and improvement of light output is strongly demanded, the arc tube wall load tends to be high, and also a distance between an electrode(s) and an inner wall of the arc tube tends to be short. It is found that, in such an extra-high pressure mercury lamp, when by passing a direct current therethrougth in an early stage of lighting, tungsten which is a component of the arc tube adheres to an inner wall of the arc tube near the coil, so that the arc tube is blackened due to discharge from the coil at the beginning of lighting. And in the case, when the arc tube is blackened, the light transmission of the arc tube falls so that the life span of the lamp is shorten.

In view of the above problem, it is an object of the present invention to provide an extra-high pressure mercury lamp having a long life span by suppressing the blackening of the arc tube.

In order to solve the above-mentioned subject, an extra-high pressure mercury lamp according to the present invention, in which 0.15 mg/mm³ or more of mercury is filled as light emitting material, and a pair of electrodes facing each other is disposed in an arc tube, at least one of the pair of electrodes has an axis portion, and a thick diameter portion formed by winding a coil around the axis portion, the thick diameter portion comprises a winding portion provided on the axis portion, and a curvature portion which is integrally formed with the axis portion and has a curved portion at least in part around a circumference of the axis portion between the axis portion and the curvature portion, and further the curved portion is connected to a back end portion of the winding portion.

In the extra-high pressure mercury lamp, the curvature portion may be integrally formed with the axis portion by a melting process.

In the extra-high pressure mercury lamp, the curvature portion may be formed all around the axis portion.

In the extra-high pressure mercury apparatus, the curvature portion may have the curved portion on a cross-section taken along a plane including a central axis, and a contact angle formed by a tangential line and a ridge line of the axis portion may be an obtuse angle.

In the extra-high pressure mercury lamp, the axis portion may have a convex portion, and the curvature portion may be integrally formed with the convex portion of the axis portion.

Further, according to the present invention, a method of producing an electrode comprise steps of winding a wire around an axis portion so as to form a winding portion, fixing the wire to the axis portion, irradiating radiation light to an back end of the winding portion so that a curvature portion is integrally formed with the axis portion.

The method may further include a step of rotating the axis portion while the step of irradiating radiation light.

In the method, the curvature portion may be formed in part around the axis portion.

Moreover, according to the present invention, an electrode for a lamp, comprises an axis portion; and a thick diameter portion provided around the axis portion, comprising a winding portion, and a curvature portion, wherein the curvature portion is integrally formed with the axis portion at a back end portion of the winding portion, and has a curved portion at least in part around a circumference of the axis portion between the axis portion and the winding portion.

When the inventors considered the cause of the blackening and paid attention to the fact that when the lamp shifts from glow discharge to arc discharge immediately after initiation of the lamp, current is concentrated at a back end portion of the coil while the discharge originated from the back end portion of the coil is carried out. And it is found out that because of the current concentration at the back end portion of the coil, tungsten is accumulated at the back end portion of the coil due to chemical reactions in the arc tube, and it grows so as to reach the inner wall of the arc tube by lighting the lamp several hundreds times.

Hereafter, a detailed description of the blackening will be given below, referring to FIGS. 5A, 5B and 5C.

FIGS. 5A, 5B, and 5C are enlarged views of an electrode. Although FIGS. 5A and 5B show the same structure, in FIG. 5A, reference numbers for explaining the structure are added, and in FIG. 5B, reference numbers for explaining chemical reactions in the arc tube are added. FIG. 5C is an enlarged view of a thick diameter portion 22 shown in FIG. 5A.

It is assumed that a length L is shorten with lighting of the lamp because of a reason as described below.

In case that the extra high pressure mercury lamp is turned on by direct current, when discharge which takes place a couple of seconds after initiation of the lamp is observed by using an oscilloscope and a video camera, a phenomenon described below is observed.

After dielectric breakdown, lighting of the lamp is initiated by mercury arc discharge (several tens of voltage), which is originated from a surface of an electrode which is a cathode 2 in a direct current, and after the mercury on the surface of the cathode 2 is completely evaporated, glow discharge (hundreds voltage) starts between the cathode 2 and an anode. When the cathode 2 is heated sufficiently by the glow discharge, it become easy to release heat electrons from the cathode 2, so that the discharge status shifts to heat arc discharge (several tens voltage) between the cathode 2 and the anode. In the glow discharge, although the discharge takes place in such manner that the entire cathode 2 is surrounded thereby, current density becomes high in a wedge-like sharp gap K between a thick diameter portion 22 comprising a coil and the axis portion 21 so that the discharge status shifts to arc discharge.

When the heat arc discharge takes place so that current is concentrated in the wedge-like sharp gap K between the thick diameter portion 22 comprising a coil and the axis portion, locally heated tungsten is evaporated so as to be scattered radially. Since the ionization voltage of the evaporated tungsten is lower than that of mercury or rear gas, it is ionized easily by the arc e. A path of the arc e is led to a portion of the inner surface of the arc tube 1, which is the closest to the back end portion of the thick diameter portion 22.

As a result, since as shown in the figure, the high temperature arc e comes in contact with or has a collision with the inner surface of the arc tube 1, a dent H is formed locally on the inner surface of the tube 1, and quartz glass (SiO₂) which is a component of the arc tube 1 is evaporated. The evaporated SiO₂ is dissociated into Si and O by discharge plasma, so that the tungsten which forms the cathode 2 is oxidized thereby evaporating as an oxide of the tungsten from the cathode 2.

The oxide of the tungsten is transferred to the back end portion of the coil so as to be accumulated as W due to elimination reaction of oxygen as shown in a broken line, so that the distance L is shortened. If this phenomenon takes place at a certain probability every time lighting of the lamp is initiated, further growth thereof occurs. Thus, the reaction cycle is repeated so that the tungsten W is accumulated so as to come in contact with the inner surface of the arc tube 1.

Although such phenomenon takes place in a discharge lamp in which a coil is placed very close to the inner surface of an arc tube, the inventors found that this does not occur if the current concentration due to the arc discharge originated from the back end portion of the coil can be suppressed from time of discharge initiation.

An extra-high pressure mercury lamp according to the present invention, comprises a thick diameter portion which is made from a coil winded around an axis portion of at least one of electrodes facing each other in an arc tube, wherein the thick diameter portion has a curvature portion connected to a back end portion of the winding portion, so that discharge starting point(s) of heat arc discharge are located in respective gaps of the winding portion, whereby it is possible to certainly prevent the back end portion (the curvature portion) of the thick diameter portion which is a portion where a distance between the cathode 2 and the inner wall of the arc tube is shortest, from becoming a starting point of discharge in case of heat arc discharge.

Therefore, even in an extra-high pressure mercury lamp in which a distance between an electrode and an inner wall of the tube is very short in order to miniaturize the lamp, and the tube wall load is large in order to increase light output, it is possible to certainly prevent the arc tube from blackening which is caused because tungsten evaporated from the electrode becomes a tungsten oxide and the oxide is accumulated at the back end of the thick diameter portion of the electrode. As a result, according to the present invention, it is possible to provide an extra-high pressure mercury lamp having a long life span.

Thus, the present invention possesses a number of advantages or purposes, and there is no requirement that every claim directed to that invention be limited to encompass all of the advantages and objects.

In addition, the foregoing has outlined rather broadly the features and technical advantages of the present invention in order that the detailed description of the invention that follows may be better understood. Additional features and advantages of the invention will be described hereinafter which form the subject of the claims of the invention.

### DESCRIPTION OF THE DRAWINGS

For a more complete understanding of the present invention, and the advantages thereof, reference is now made to the following descriptions taken in conjunction with the accompanying drawings, in which:

FIG. 1 is a cross-sectional view of an extra-high pressure mercury lamp according to the present invention;

FIG. 2A is a front elevational view thereof;

FIG. 2B is an enlarged cross-sectional view taken along a plan including a central axis of the cathode 2;

FIGS. 3A, 3B, and 3C are schematic diagrams for explaining an example of the manufacturing method of the cathode 2;

FIG. 4A shows a front elevational view of the cathode thereof;

FIG. 4B is an enlarged view thereof taken along a plane including a central axis of the anode 2; and

FIGS. 5A, 5B, and 5C are enlarged views of an electrode.

### DETAILED DESCRIPTION OF THE INVENTION

Description of the present invention be given, referring to Embodiments. While the present invention is not necessarily limited to such embodiments, an appreciation of various aspects of the invention is best gained through a discussion of various examples in such an application.

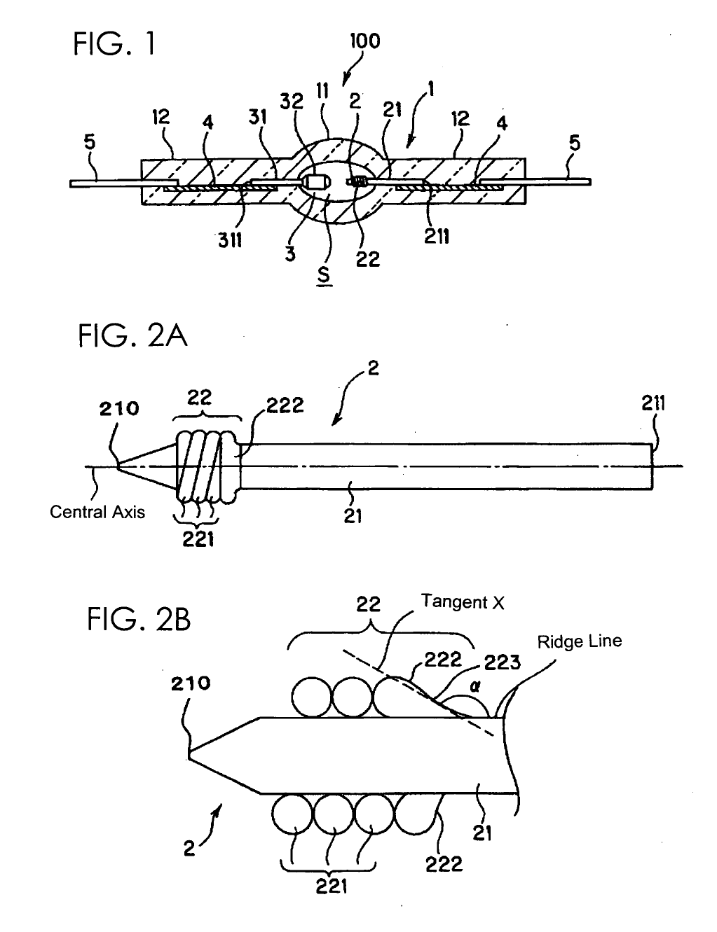

FIG. 1 is a cross-sectional view of an extra-high pressure mercury lamp according to the present invention.

The extra-high pressure mercury lamp 100 has an arc tube 1 made of, for example, quartz glass. The arc tube 1 has an approximately spherical light emitting portion 11 and rod-shaped seal portions 12 which are connected to respective ends of the light emitting portion 11. In an inner space S of the arc tube 11, a cathode 2 and an anode 3 are disposed facing each other. The cathode 2 has an axis portion and a thick diameter portion 22 formed by winding a coil around the axis portion 21. The anode 3 has an axis portion 31 and a thick diameter portion 32 which is formed at the tip of the axis portion 31. In each of the seal portions 12, metallic foil 4 for power supply, which is, for example, made of molybdenum is buried and air-tightly sealed. The metallic foils 4 are electrically connected to a base end portion 211 of the axis portion 21, and a base end portion 311 of the axis portion 31 at one end, respectively, by melting, and at the other end thereof, they are connected to respective external leads 5 for power supply which extend toward the outside of the seal portion 12.

In the arc tube 1, mercury, halogen gas, and rare gas is enclosed.

The mercury is used in order to obtain radiation of desirably visible light wavelength, for example, 360-780 nm, wherein 0.15 mg/mm³ or more of mercury is filled therein so that the mercury vapor pressure is 150 or more atmospheric pressure at time of lighting. The amount of mercury can be suitably changed according to desired mercury vapor pressure, although depending on temperature conditions. For example, 13 kPa of argon gas is filled as rare gas therein so that the lighting initiation property is improved.

The filled amount of halogen is selected from the range of, for example, 10⁻⁶ to 10⁻¹ μmol/mm³, for example, 3.0×10⁻⁴ μmol/mm³, wherein the halogen is enclosed in form of chemical compound of iodine, bromine, chlorine etc and mercury or other metals. Although the function of the halogen is to extend the life span of the discharge lamp due to using the halogen cycle, in case of an extremely small discharge lamp with high inner pressure, there is an advantage that devitrification of the arc tube is prevented by enclosing halogen.

FIGS. 2A and 2B show enlarged views of the cathode 2. FIG. 2A is a front elevational view thereof. FIG. 2B is an enlarged cross-sectional view taken along a plane including a central axis of the cathode 2.

In FIGS. 2A and 2B, the same reference numbers as those shown in FIG. 1 are used for the same structures, respectively.

As shown in FIG. 2A, the cathode 2 has the axis portion 21 and the thick diameter portion 22 which is formed by winding a linear wire made of tungsten in form of a coil in the side of the tip 210 of the axis portion 21.

In details, the thick diameter portion 22, has two or more winding portions 221 which are formed by winding the linear wire made of tungsten in form of a coil, and a curvature portion having a curved surface connected to the back portion of the winding portion 221 (in the side of base end portion 221).

While at time of initiation of lamp lighting, the winding portions 221 functions as a seed of lighting (a position of lighting initiation) due to a surface concavo-convex effect, it has a heat radiation function due to the surface concavo-convex effect and increase of the surface heat capacity after the lighting is initiated. Moreover, the tungsten wire which is winded in form of coil is thin so that it is easy to be heated, thereby making the shift from the glow discharge to the heat arc discharge easy.

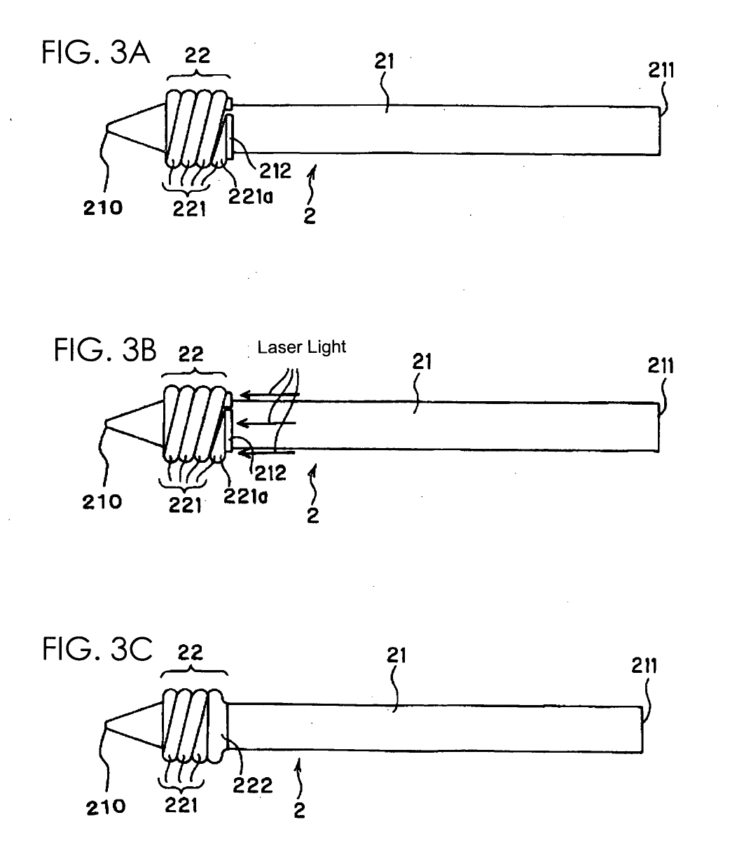

The curvature portion 222 is integrally formed with the axis portion 21 by carrying out a heat processing to a far back end of the winding portion in the circumferential direction so as to melt them in a state where the tungsten wire is winded around the axis portion 21 (FIG. 3) as described below. As shown in FIG. 2B, the curvature portion 222 has a curved portion 223 in the cross-section containing the central axis of the electrode 2. And a contact angle α formed by a tangential-line X of the curved portion 223 and a ridge line of the axis portion 21 is an obtuse angle (>90 degree). According to the embodiment of the present invention, the tangential line may be drawn at any point of the curved portion 223.

A manufacturing method of the cathode 2 according to the present invention will be described below referring to FIGS. 3A, 3B, and 3C.

FIGS. 3A, 3B, and 3C are schematic diagrams for explaining an example of the manufacturing method of the cathode 2.

FIG. 3A shows a state before the cathode 2 is produced.

A wire made of tungsten is winded around the axis portion 21 made of tungsten, so as to be single-layered so that two or more winding portions 221 are formed. A winding portion 221a located at the far back end thereof has an edge portion formed by cutting the wire by a grinder at its end portion. In this state, the winding portion 221 is fixed to the axial portion 21 by means, such as a caulking. In addition, the convex section 212 is formed in the circumferential direction of the axis portion 21, and the tungsten wire is attached to the convex section 212 so that the winding portion 221a adjoins the convex section 212. When laser is irradiated (as described below), the convex section 212 easily rises in temperature, so that it easily fits on the winding portion 221a by the melting. In addition, by inserting the coil so as to abut on the convex section provided in the axial portion near the back end portion of the coil, it is possible to raise the accuracy of position of the back end portion thereby minimizing variation in a laser emitting position.

FIG. 3B shows a state of the cathode 2 where laser light is emitted to all around the winding portion 221a located at the far back end (the base end portion 221 of the axis portion 21), from a central axis direction.

The laser light is radiation light, such as CO₂ laser and YAG laser. In particular, the melting process is carried out by rotating the cathode 2 in the radial direction and irradiating laser light to the winding portion 221a located at the far back end or to the convex section 212, so that the winding portion 221a and the convex section 212 are selectively and locally heated. As for irradiation of this laser light, it is desirable to irradiate laser light to these portions in an inert gas atmosphere, such as argon gas, from a viewpoint of preventing oxidization of the electrodes. Moreover, although laser light can be irradiated continuously, it is possible to irradiate the laser light in form of pulse. In such pulse irradiation, short time irradiation and break (on a millisecond order) is repeated, wherein it is more effective than the ordinary continuous irradiation type pulse.

FIG. 3C shows a state where the curvature portion 222 is formed by the irradiation of the laser light. Since the winding portion 221a is melted all around the axes portion, no wedge-shaped gap having an acute angle with respect to the axis portion 21 is formed, and the winding portion 221a is integrally formed with the axis portion 21. The curvature portion 222 having the curved surface which is formed in the melting process is formed.

In addition, the curvature portion 222 may not be necessarily formed by melting only one winding portion located in the back end side, and may be formed by melting two or more winding portions 221 from the far end side. That is, the “curvature portion” means a portion(s) which are melted among the winding portions 221 and are integrally formed with the axis portion 221.

A numerical example concerning cathode 2 is given below.

A diameter of the axis portion 21 is the range of 0.3 mm-3 mm, for example, 0.8 mm, the volume thereof is the range of 4 mm³-40 mm³, for example, 23 mm³, the surface area is 10 mm²-45 mm², for example, 20 mm², and the full length thereof is 7 mm-20 mm, for example, 10 mm. A half of the full length of the axis portion 21 is buried in the sealing portion 12 and the other half is exposed in the inner space S. The diameter of the tungsten wire which forms the winding portion 221 is 0.2 mm-0.6 mm, for example, 0.25 mm, and the number of turns of windings is 2-10, for example, are three turns.

In addition, the purity of the tungsten which forms the axis portion 21 and a winding portion 221, is desirably, 99.99% or more. This is because if much impurity is contained when melting, the winding portion foams, and projection(s), on a surface of which an electric-field(s) is easily concentrated, is formed.

Furthermore, the numerical example concerning manufacture of the cathode 2 is given to below.

A beam diameter of the laser light is 0.04 mm-0.7 mm, for example, 0.3 mm, and irradiation time is 0.2-1.0 seconds, for example, 0.35 seconds.

In the extra-high pressure mercury lamp according to the embodiment of the present invention, since the thick diameter portion 22 of the cathode 2 comprises the curvature portion 222 having the cured portion which is formed at the back end of the coil-like winding portion 221 between the axis portion 21 and the winding portion, wherein the curvature portion is integrally formed with the axis portion 21, so that there is no wedge-like gap between the back end of the thick diameter portion 22 and the axis portion 21, current is not concentrated at the back end of the thick diameter portion 22 during the above heat arc discharge.

Consequently, since the tungsten which is heated locally is not evaporated so as to scatter radially from an inner surface of the arc tube so that a path of the arc is not led to a portion of the inner surface, the high temperature arc does not come in contact with or has a collision with the inner surface of the arc tube. Therefore, since such a series of phenomena, in which quartz glass (SiO₂), a component of the arc tube, is evaporated so that oxygen becomes superfluous in a gaseous phase, and tungsten, a component of the electrodes, is oxidized so that tungsten oxide which is generated by evaporation of tungsten is accumulated at the back end of the thick diameter portion, do not occur, it is possible to prevent the arc tube well from blackening.

Namely, by adopting the structure according to the embodiment of the present invention, the electric discharge starting points during the heat arc discharge are gaps between the winding portions 221, whereby the back end portion (curvature portion 222) of the thick diameter portion 22 which is a portion where the distance between the cathode 2 and the inner surface of the arc tube 1 is the shortest, can be prevented certainly from becoming a starting point of heat arc discharge, so that it is possible to prevent, from blackening, even an arc tube of an extra-high pressure mercury lamp in which a distance between an electrode and an inner wall of the arc tube is extremely short in order to miniaturize the lamp, and a tube wall load of the lamp is made in order to increase light output.

In addition, in the extra-high pressure mercury lamp according to the embodiment of the present invention, as mentioned above, although the electric discharge starting points during the heat arc discharge are the gaps between the wires of the winding portion 221 or a front end portion of the thick diameter portion 22, since the distances between these portions and the inner wall of the arc tube are longer than that between the back end portion of the thick diameter 22 and the inner wall of the arc tube, there is little possibility that arc comes in contact with or has collision with the inner surface of the arc tube.

Furthermore, in the extra-high pressure mercury lamp according to the embodiment of the present invention, since a tungsten oxide is not generated as mentioned above, it is possible to certainly prevent the shape of the cathode 2 from changing due to, for example, formation of projections on the cathode 2, as time passes. Thereby, it is possible to prevent a problem that flux of light decreases since wavelength of emitted light becomes short due to the formation of the projections at the tip of the cathode 2, and a problem that light of the lamp flickers since the arc luminescent spot shifts between the projections due to the formation of two or more projections on the cathode 2.

The present invention is not limited to the above embodiments and various changes to the embodiments can be made.

For example, the curvature portion in the thick diameter portion of the cathode 2 may not necessarily be formed by melting the coil-like winding portion provided on the axis portion, and may be formed as described below.

That is, in particular, an additional tungsten wire having a 0.1 mm diameter which is shorter than that of the tungsten wire which forms the winding portion may be winded around a gap between the far back end of the winding portion and the axis portion, and laser light may be irradiated to the additional tungsten wire so as to be melted thereby forming a curvature portion. In addition, the curvature portion may be formed by filling and melting powder made of, for example, tungsten, which functions as a binder, in the gap between the far back side of the winding portion and the axis portion.

Furthermore, pressure melting and milling processes may be performed beforehand to a far back end portion of a tungsten wire which becomes a winding portion, so that the gap between the winding portion located at the far back end and the axis portion are eliminated, and the above mentioned contact angle turns into an obtuse angle.

The bottom line is, a (wedge-shaped sharp) gap(s) is filed in since if there is the gap between the winding portion located at the back end and the axis portion, it is expected that current is concentrated therein during heat arc discharge.

Furthermore, the thick diameter portion of the cathode 2 according to another embodiment of the present invention will be described below.

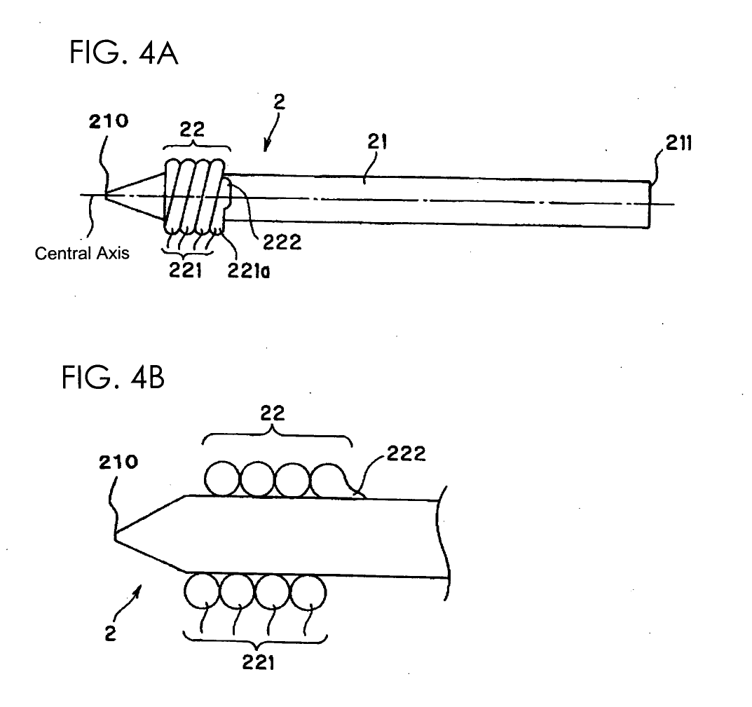

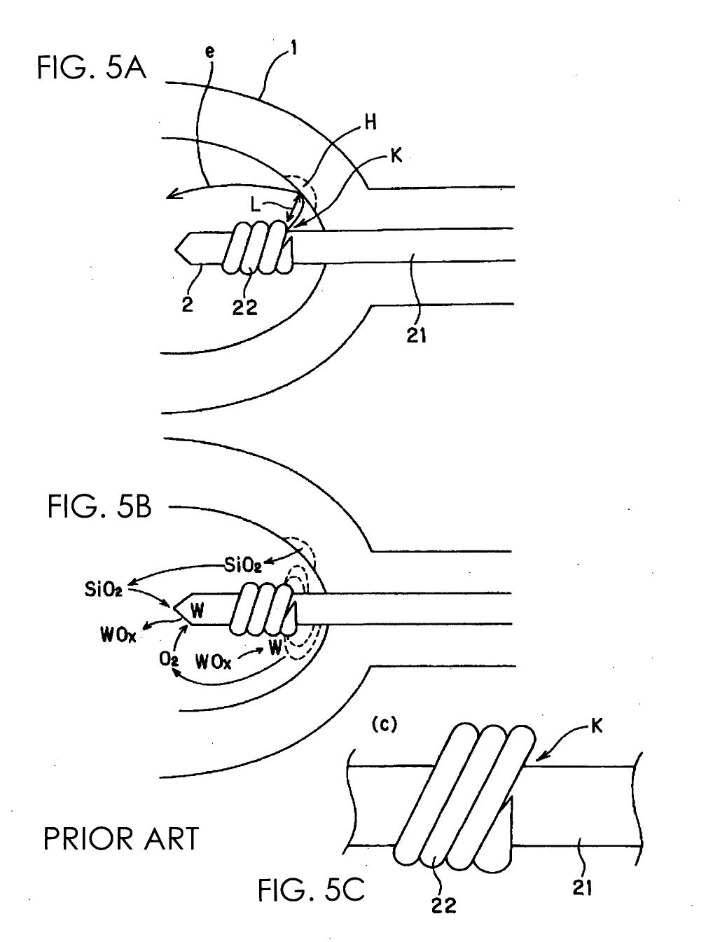

FIG. 4A shows a front elevational view of the cathode 2 thereof. FIG. 4B is an enlarged view thereof taken along a plane including a central axis of the cathode 2.

As shown in FIGS. 4A and 4B, a curvature portion 222 can also be formed only in part instead of the entire the circumference of the winding portion 221a located at the far back end portion.

In this case, irradiation of laser light may be adjusted suitably in the stage of irradiating laser light to the winding portion shown in FIGS. 3B and 3C.

In the cathode 2 shown in FIGS. 4A and 4B according to the embodiment of the present invention, as compared with the conventional structure having no curvature portion, it is possible to not only control blackening of the arc tube but also improve productivity thereof since time for irradiating laser light to the winding portion can be shortened so that time for manufacturing can be shortened.

A means for melting the coil-like winding portion, is not limited to laser light, and any means such as electron beam can be utilized as long as high energy can be given to the winding portion. As to the electron beam, an electron beam apparatus disclosed in, for example, Japanese Laid Open Patent Nos. 2001-59900 and 2001-174596 is desirable since the electron beam apparatus is small in size.

In the above-mentioned embodiments, the cathode 2 of a direct current lighting type extra-high pressure mercury lamp is described, the present invention is not limited to a cathode 2 of such a type of lamp. That is, the present invention can be also applied to an extra-high pressure mercury lamp of an alternate-current lighting system since one of electrodes functions by turns as a cathode 2 which takes on glow discharge.

Hereafter, an experiment which was conducted in order to confirm the effects and operations of the embodiments of the present invention will be explained.

### Embodiments

According to the structures shown in FIGS. 1 and 2 and FIGS. 1 and 4, respectively, six extra-high pressure mercury lamps according to the embodiments of the present invention were prepared. The structural detail of the extra-high pressure mercury lamp is described below.

The arc tube 1 was a sealed container made of quartz glass and having a 74 mm full length, wherein the maximum external diameter of the arc tube 11 was 10 mm and the internal volume thereof was 66 cm³. The outer diameter of the sealed portion 12 was 6.5 mm.

The axis portion 21 which forming the cathode 2 was made of tungsten, wherein the outer diameter thereof was 0.8 mm, the full length thereof was 11 mm, and the tip thereof was tapered. The thick diameter portion 22 was formed by winding a tungsten wire having a 0.25 mm diameter about the axis portion 21 in form of a coil. The coil-like winding portion 221 was formed by three turns, and the pitch thereof was 0.3 mm. The curvature portion 222 whose structure was shown in FIGS. 2A and 2B, was formed by the steps shown in FIGS. 3A-3C.

The axis portion 31 which forms the anode 3 was made of tungsten, wherein the outer diameter was 0.8 mm and the full length thereof was 13 mm. The maximum outer diameter of the thick diameter portion 32 was 1.8 mm and the full length thereof was 3 mm.

The electrode distance between the cathode 2 and the anode 3 was 1.1 mm.

In the arc tube 1, 1.8 mg of mercury, 13 kPa of argon gas, and 3.0×10⁻⁴ μmol/mm³ of bromine gas was enclosed.

### COMPARATIVE EXAMPLES

Three extra-high pressure mercury lamps according to the comparative example, having the same structure as that of the extra-high pressure mercury lamp according to the embodiment of the present invention, except for having no curvature portion in the thick diameter portion of the cathode 2 were produced.

Occurrence of blackening on the arc tube was observed, after an operation in which each of these extra-high pressure mercury lamps according to the embodiment of the present invention and the comparative example was turned on on condition of 70 V rated voltage and 200 W rated power for five minutes and turned off for five minutes, was repeated predetermined times.

The result of the experiment is shown in Table 1.

TABLE 1

| | Times of turning on and off | | |
|---|---|---|---|
| | 100 Times | 300 Times | 500 Times |
| Example 1 | ⊚ | ⊚ | ◯ |
| Example 2 | ⊚ | ⊚ | ◯ |
| Example 3 | ⊚ | ⊚ | ◯ |
| Example 4 | ◯ | ◯ | Δ |
| Example 5 | ◯ | ◯ | Δ |
| Example 6 | ◯ | ◯ | Δ |
| Comparative | Δ | X | X |
| Example 1 | | | |
| Comparative | Δ | X | X |
| Example 2 | | | |
| Comparative | Δ | X | X |
| Example 3 | | | |

In Examples 1-3 shown in Table 1, the lamps had a curvature portion between the axis portion and the winding portion, respectively, in which the winding portion located at the far back end was melted all around the axis portion, and a contact angle α was an obtuse angle, as shown in FIG. 2.

In Examples 4-6, the lamps had a curvature portion between the axis portion and the winding portion, respectively, in which part of the winding portion located at the far back end was melted, and a contact angle α was an obtuse angle as shown in FIG. 4.

Moreover, in Table 1, “100 Times” means that the operation of turning on and off as mentioned above was repeated 100 times.

“300 Times” and “500 times’ means that the operation of turning on and off was repeated 300 times and 500 times respectively.

Moreover, in Table 1, symbols show occurrence of blackening on the arc tube. Specifically “⊚” means that no blackening was found even it was observed by a microscope, “◯” means that blackening was observed slightly by the microscope, “Δ” means that blackening was easily observed by the microscope, and “x” means that blackening was observed by the naked eye.

As shown in the result in Table 1, when, as in the extra-high pressure mercury lamp of the Example 1, a portion of the winding portion which was located at the far back end portion of the thick diameter portion of the cathode 2 was melted all around the axis portion so as to form a curvature portion so that the contact angle α was obtuse, blackening of the arc tube was most effectively prevented. Moreover, in the case where only part of the winding portion which was located at the far back end portion was melted, it was confirmed that blackening of the arc tube was prevented, as compared with the conventional extra-high pressure mercury lamps as long as the contact angle α is obtuse.

Thus the present invention possesses a number of advantages or purposes, and there is no requirement that every claim directed to that invention be limited to encompass all of the advantages and purposes.

The disclosure of Japanese Patent Application No. 2004-264052 filed on Sep. 10, 2004 including specification, drawings and claims is incorporated herein by reference in its entirety.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

What is claimed is:

1. An extra-high pressure mercury lamp in which 0.15 mg/mm3 or more of mercury is filled as light emitting material, and a pair of electrodes facing each other is disposed in an arc tube, wherein at least one of the pair of electrodes has an axis portion, and a thick diameter portion formed by winding a coil around the axis portion, the thick diameter portion comprising a winding portion provided on the axis portion, and a curvature portion which is integrally formed with the axis portion, and has a curved portion at least in part around a circumference of the axis portion between the axis portion and the winding portion, and the curved portion connected to a back end portion of the winding portion.

2. The extra-high pressure mercury lamp according to claim 1, wherein the curvature portion is integrally formed with the axis portion by a melting process.

3. The extra-high pressure mercury lamp according to claim 1, wherein the curvature portion is formed all around the axis portion.

4. The extra-high pressure mercury apparatus according to claim 1, wherein the curvature portion has the curved portion on a cross-section taken along a plane including a central axis, and a contact angle formed by a tangential line and a ridge line of the axis portion is an obtuse angle.

5. The extra-high pressure mercury lamp according to the claim 1, wherein the axis portion has a convex portion, and the curvature portion is integrally formed with the convex portion of the axis portion.

6. A method of producing an electrode, the method comprising the following steps of:
winding a wire around an axis portion so as to form a winding portion;
fixing the wire to the axis portion;
irradiating radiation light to an back end of the winding portion while the axis portion is rotated so that a curvature portion is integrally formed with the axis portion.

7. The method according to claim 6 wherein the curvature portion is formed in part around the axis portion.

8. The method according to claim 6, further including winding an additional wire around the back end of the winding portion before the step of irradiating radiation light.

9. The method according to claim 6, wherein the radiation light is laser or electron beam.

10. The method according to claim 9, wherein the laser is CO₂ laser or YAG laser.

11. The method according to claim 6, wherein the step of irradiating radiation light is carried out in an inert gas atmosphere.

12. The method according to claim 6, wherein in the step of irradiating radiation light, irradiation of radiation light and a break is repeated by turns.

13. The method according to claim 6, wherein in the step of irradiating radiation light, radiation light is continuously irradiated.

14. An electrode for a lamp, comprising:
an axis portion; and
a thick diameter portion provided around the axis portion, comprising a winding portion, and a curvature portion,
wherein the curvature portion is integrally formed with the axis portion at a back end portion of the winding portion, and has a curved portion at least in part around a circumference of the axis portion between the axis portion and the winding portion.

15. The electrode according to claim 15, wherein the thick diameter portion is made from a coil.
